(19) United States
(12) Patent Application Publication
(10) Pub. No.: US 2011/0155346 A1
(43) Pub. Date: Jun. 30, 2011

(54) HEAT DISSIPATION DEVICE WITH FAN HOLDER

(75) Inventor: JIAN YANG, Shenzhen City (CN)

(73) Assignees: FU ZHUN PRECISION INDUSTRY (SHEN ZHEN) CO., LTD., Shenzhen City (CN); FOXCONN TECHNOLOGY CO., LTD., Tu-Cheng (TW)

(21) Appl. No.: 12/824,235

(22) Filed: Jun. 28, 2010

(30) Foreign Application Priority Data
Dec. 30, 2009 (CN) 200910312577.5

(51) Int. Cl. G06F 1/20

(52) U.S. Cl. 165/80.2

(57) ABSTRACT

A heat dissipation device includes a base plate, a bracket engaged with the base plate, a heat radiator mounted on the base plate and the bracket, a fan holder and a fan mounted on the fan holder. The base plate has first and second faces at opposite sides thereof. The bracket includes two opposite arms, and a first wall and a second wall interconnecting ends of the arms and defining an opening receiving the base plate. Each of the first and second walls has a baffle extending obliquely therefrom. The heat radiator has a contact surface contacting the base and a lateral locating surface abutting against the baffles. The heat radiator also has a slot defined therein. The fan holder comprises a top plate, and a clamping leg and two tabs extending downwardly from the top plate, the clamping leg fittingly received in the slot of the heat radiator.

### BACKGROUND

1. Technical Field

The present disclosure relates to a heat dissipation device and, more particularly, to a heat dissipation device for cooling an electronic component, such as an integrated circuit package. The heat dissipation device has a fan holder to which a fan is attached.

2. Description of Related Art

Many electronic components, such as central processing units (CPUs), comprise numerous circuits operating at high speed and generating substantial heat. Under most circumstances, it is necessary to cool the CPUs in order to maintain safe operating conditions and assure that the CPUs function properly and reliably. In the past, various approaches have been used to cool electronic components. Typically, a heat dissipation device is attached to an outer surface of a CPU to remove the heat therefrom.

In many applications, the electronic component is mounted on a printed circuit board. A typical heat dissipation device generally comprises a base for absorbing heat from the electronic component, a fin assembly soldered on the base, and a bracket engaged with the base for mounting the base onto the printed circuit board. The base absorbs heat from the electronic component and transfers the heat to the fin assembly, whereupon the heat dissipates into the ambient air. The bracket is fixed to the base by screws. It is necessary to use a screwdriver or other tool to manipulate the screws. Therefore it is somewhat inconvenient to assemble the heat dissipation device. Furthermore, a fan holder is used for connecting a fan onto the fin assembly. It is somewhat inconvenient to have to assemble the fan holder onto the fin assembly.

Accordingly, what is needed is a heat dissipation device which can overcome the above-mentioned problems and shortcomings.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is an assembled, isometric view of a heat dissipation device in accordance with an embodiment of the present disclosure.

FIG. 2 is an exploded view of the heat dissipation device of FIG. 1.

FIG. 3 is an inverted view of the heat dissipation device shown in FIG. 2.

FIG. 4 is an inverted view of the heat dissipation device shown in FIG. 1.

### DETAILED DESCRIPTION

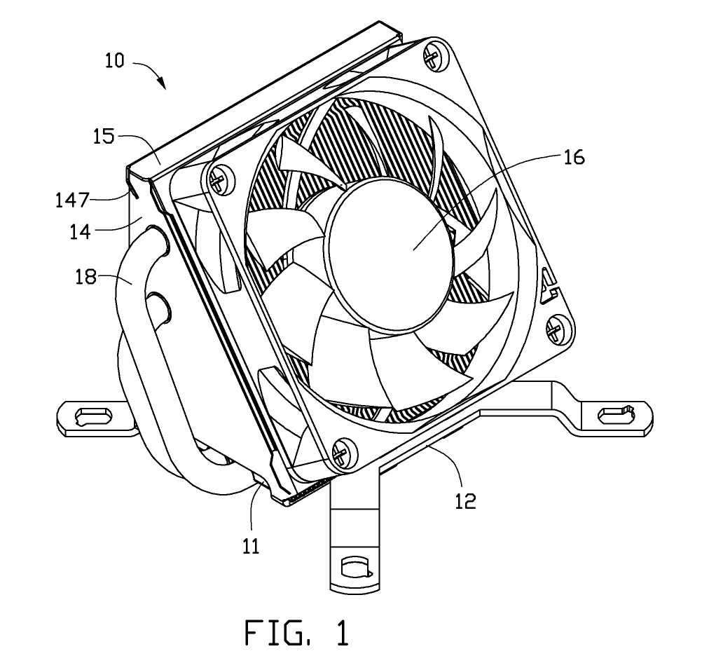

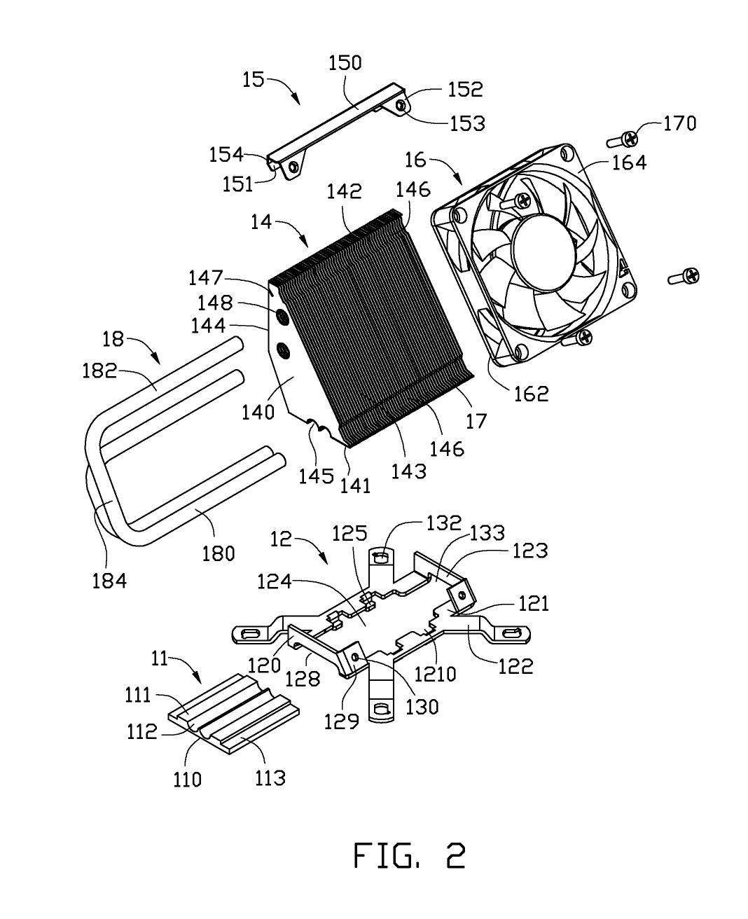

Referring to FIGS. 1-2, a heat dissipation device 10 in accordance with an embodiment of the present disclosure is shown. The heat dissipation device 10 is for mounting onto a printed circuit board (not shown) to remove heat from a heat-generating electronic component (not shown) attached on the printed circuit board. The electronic component can for example be a CPU (not shown). The heat dissipation device 10 comprises a base plate 11, a heat radiator 14, a bracket 12 engaging the base plate 11 with the heat radiator 14, a pair of heat pipes 18 connecting the base plate 11 with the heat radiator 14, a fan holder 15 engaging on the heat radiator 14, and a fan 16 mounted on the heat radiator 14 via the fan holder 15.

The base plate 11 has a rectangular configuration, and has a bottom surface 110 for contacting a top of the heat-generating electronic component. The base plate 11 comprises a top inserting portion 111 with a width less than that of the base plate 11. Two notches 113 are thereby defined in the base plate 11 at two opposite outer sides of the inserting portion 111, respectively. The base plate 11 also defines two parallel grooves 112 at a middle of the inserting portion 111 thereof. Each of the grooves 112 is parallel to the notches 113, and defines a semicircular transverse cross-section.

The bracket 12 is a single piece of metal shaped by methods such as punching. The bracket 12 includes a rectangular frame (not labeled), and four ears 122 extending in four different directions from four points of the frame. The bracket 12 defines an opening 124 in a central portion thereof. The opening 124 has a shape similar to that of the inserting portion 111 of the base plate 11. The bracket 12 includes two opposite arms 121, and a first wall 120 and a second wall 123 interconnecting ends of the arms 121, respectively. Thus, one of the arms 121, the first wall 120, the other arm 121 and the second wall 123 arranged end to end cooperatively surround the opening 124.

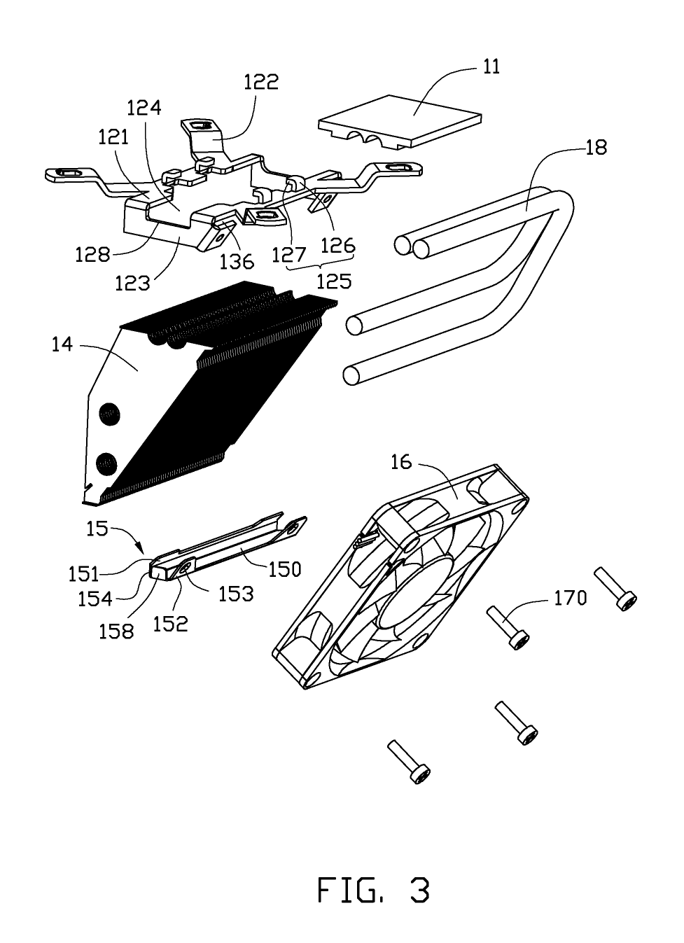

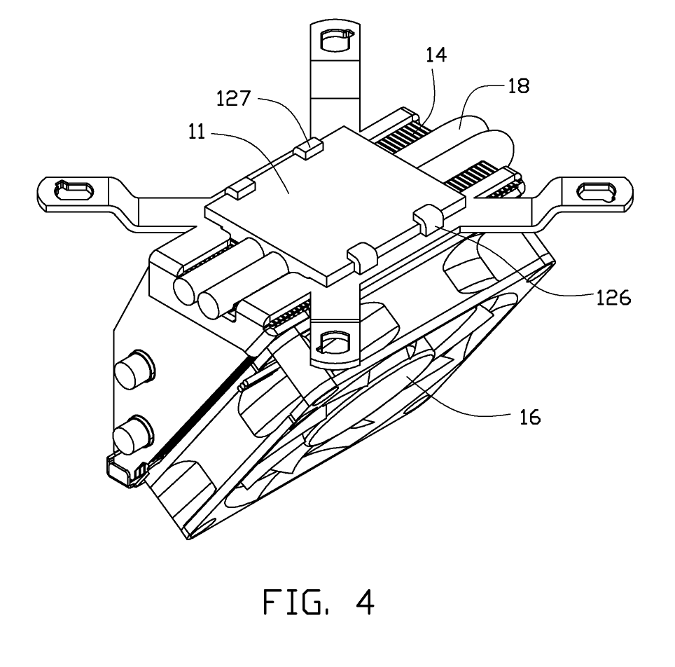

Referring also to FIGS. 3-4, the arms 121 are positioned horizontally, and have planar top surfaces (not labeled). An inner edge of each arm 121 is punched to define two cutouts 1210, and to form two clasps 125 extending downwardly from the inner edge. The cutouts 1210 of the arms 121 are communicated with the opening 124 of the frame. Each of the clasps 125 is L-shaped, and comprises a connecting part 126 extending downwardly from the arm 121 and a blocking part 127 extending from a free end of the connecting part 126. The connecting part 126 is perpendicular to the corresponding arm 121, and the blocking part 127 is perpendicular to the connecting part 126 and parallel to the arm 121. Therefore, the blocking parts 127 are below and spaced from the arms 121. The two blocking parts 127 of one arm 121 face the two blocking parts 127 of the other arm 121.

Each of the first and second walls 120, 123 is plate-shaped and upright, and interconnects corresponding ends of the arms 121. The first wall 120 defines a first undercut 128 at a bottom thereof, and the second wall 123 defines a second undercut 133 at a bottom thereof. The first undercut 128 and the second undercut 133 have rectangular shapes, and are communicated with the opening 124. The first undercut 128 has a height larger than a thickness of the inserting portion 111, and a width the same as that of the inserting portion 111. In this embodiment, the first undercut 128 is wider than the second undercut 133 so that the base plate 11 can extend through the first undercut 128 and abut against the bracket 12 at the second undercut 133. Each of the first and second walls 120, 123 has an inclined baffle 129 extending from a lateral end thereof, respectively. The baffles 129 are located at the one same arm 121, and are aligned (coplanar) with each other. A first acute angle (not shown) is defined between each of the baffles 129 and the arm 121. A slit 136 (see FIG. 5) is defined between a bottom edge of each baffle 129 and the arm 121. Each of the baffles 129 defines a screw hole 130 therein.

The heat radiator 14 comprises a plurality of fins 140. The fins 140 are stacked together and mounted on the base plate 11. The fins 140 are separated from each other at uniform intervals to define a plurality of air channels (not labeled). The heat radiator 14 has a wedge-shaped structure. The wedge-shaped structure defines a bottom contact surface 141, a top surface 142, a lateral locating surface 143, and a back surface 144 between the bottom contact surface 141 and the top surface 142. The air channels are exposed at both the lateral locating surface 143 and the back surface 144. The bottom contact surface 141 engages a top of the inserting portion 111 of the base plate 11. The heat radiator 14 defines two grooves 145 at the bottom contact surface 141, corresponding to the grooves 112 of the base plate 11. The grooves 145 cooperate with the grooves 112 to define channels (not labeled) for receiving the heat pipes 18 when the fins 140 of the heat radiator 14 are stacked together and mounted onto the base plate 11. The heat radiator 14 defines a pair of through holes 148 at a top portion thereof to receive the heat pipes 18. A fan (not shown) can be mounted on the lateral locating surface 143 of the heat radiator 14. The lateral locating surface 143 is inclined with respect to the bottom contact surface 141.

A second acute angle (not shown) is defined between the lateral locating surface 143 and the bottom contact surface 141. The second acute angle corresponds to the first acute angle defined between each of the baffles 129 and the arm 121. In particular, the second acute angle is substantially equal to the first acute angle. The heat radiator 14 defines two grooves 146 at the lateral locating surface 143, near the bottom contact surface 141 and the top surface 142, respectively. The heat radiator 14 forms a flange 17 at an edge of the bottom contact surface 141. The flange 17 is received in the slits 136 between the baffles 129 and the arm 121 of the bracket 12. The back surface 144 is opposite to the lateral locating surface 143. The heat radiator 14 defines a slot 147 at the back surface 144, near the top surface 142

The heat pipes 18 are U-shaped. Each heat pipe 18 comprises a horizontal evaporating portion 180, a condensing portion 182 parallel to the evaporating portion 180, and an adiabatic portion 184 interconnecting the evaporating portion 180 and the condensing portion 182.

The fan holder 15 engages the top portion of the heat radiator 14. The fan holder 15 comprises a top plate 150, a pair of tabs 152 extending from a front edge of the top plate 150, a baffle wall 154 extending perpendicularly from a rear edge of the top plate 150, and a pair of clamping legs 151 extending from two ends of a bottom edge of the baffle wall 154. A blocking portion 158 extends downwardly from a right end of the top plate 150. The top plate 150 corresponds to the top surface 142 of the heat radiator 14. Each of the tabs 152 defines a screw hole 153 thereon. The tabs 152 are positioned on the lateral locating surface 143 of the heat radiator 14. The clamping legs 151 are configured to be slidingly inserted into the slot 147 of the heat radiator 14, with the clamping legs 151 fittingly sliding along the slot 147.

The fan 16 has a square configuration and comprises a pair of parallel plates 162, 164. Four screws 170 extend through four corners of the fan 16 to threadedly engage in the screws holes 153 of the tabs 152 of the fan holder 15 and in the screw holes 130 of the baffles 129, respectively, whereby the fan 16 is mounted to the lateral locating surface 143 of the heat radiator 14 by the fan holder 20 and the bracket 12. The grooves 146 of the heat radiator correspond to the baffles 129 of the bracket 12 and to the tabs 152 of the fan holder 15, respectively, and provide gaps to enable the above-described assembly of the screws 170.

In assembly of the heat dissipation device 10, the base plate 11 extends through the first undercut 128 from an outer side of the bracket 12, until the base plate 11 abuts against inner shoulders (not labeled) of the bracket 12 near the second undercut 133. In other words, the base plate 11 slides into the bracket 12 along a transverse direction. The base plate 11 is sandwiched between the blocking parts 127 of the clasps 125 and the arms 121, to firmly engage the bracket 12. The inserting portion 111 is received in the opening 124 of the bracket 12 and has a top surface parallel to a top surface of the arms 121 of the frame 41. The top surface of the base plate 11 and the bottom contact surface 141 of the heat radiator 14 are attached together with solder paste. The heat radiator 14 is placed on the inserting portion 111 of the base plate 11 and pushed along a lengthwise direction toward the baffles 129. The flange 17 of the heat radiator 14 inserts into the slits 136 between the baffles 129 and the corresponding arm 121. The heat radiator 14 is mounted on the arms 121 of the frame and sandwiched between the first and second walls 120, 123 of the bracket 12.

Then the evaporating portions 180 of the heat pipes 18 extend through the first undercut 128 of the first wall 120, the channels 62 cooperatively defined by the grooves 145 of the heat radiator 14 and the grooves 112 of the base plate 11, and the second undercut 133 of the second wall 123. The condensing portions 182 of the heat pipes 18 extend through the through holes 148 of the heat radiator 14. Thereby, the heat radiator 14 is located in transverse directions by the first and second walls 120, 123, and located in lengthwise directions by the baffles 129 and the evaporating portions 180 of the heat pipe 18. Then, the heat dissipation device 10 is heated at high temperature to solder the base plate 11, the heat radiator 14, and the heat pipes 18 together.

Furthermore, the fan holder 15 slides on the top surface 142 of the heat radiator 14 from an outer side of the bracket 12 along a transverse direction (such transverse direction being opposite to the transverse direction along which the base plate 11 is slid into the bracket 12). The clamping legs 151 are thus slidingly inserted into the slot 147 of the heat radiator 14, until the blocking portion 158 abuts against an outside fin 140 of the heat radiator 14. In this embodiment, the base plate 11 and the fan holder 15 are positioned at opposite sides of heat radiator 14, and both the base plate 11 and the fan holder 15 are oriented along the transverse directions. Finally, the fan 16 is mounted to the baffles 129 of the bracket 12 and the tabs 152 of the fan holder 15. Thus, the heat dissipation device 10 is assembled.

Advantages of the heat dissipation device 10 include the following. With the provision of the clasps 125 of the bracket 12 clamping the base plate 11, the heat dissipation device 10 is assembled conveniently and firmly, thereby reducing manufacturing costs of the heat dissipation device 10. Simultaneously, the first and second walls 120, 123, the baffles 129, and the evaporating portions 180 of the heat pipe 18 together locate the heat radiator 14 in transverse directions and in lengthwise directions. Thus a strength of the heat dissipation device 10 is improved. In addition, with the provision of the clamping legs 151 of the fan holder 15 fittingly slidable along the slot 147 of the heat radiator 14, the fan holder 15 together with the fan 16 can be easily and reliably mounted to the heat radiator 14.

It is to be understood, however, that even though numerous characteristics and advantages of various embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A heat dissipation device for an electronic component, the heat dissipation device comprising:
a base plate having first and second faces at opposite sides thereof, the first face capable of contacting the electronic component;
a bracket engaged with the base plate, the bracket comprising two opposite arms, and a first wall and a second wall interconnecting ends of the arms, the first wall, the second wall, and the arms together defining an opening therebetween, the opening receiving the base plate, each of the first and second walls having a baffle extending obliquely therefrom;
a heat radiator mounted on the second face of the base plate and the bracket, the heat radiator having a contact surface contacting the base and a lateral locating surface abutting against the baffles, the heat radiator also having a slot defined therein;
a fan holder comprising a top plate, and a clamping leg and two tabs extending downwardly from the top plate, the clamping leg fittingly received in the slot of the heat radiator; and
a fan mounted on the baffles of the bracket and the tabs of the fan holder and thereby positioned to provide airflow toward the lateral locating surface of the heat radiator.

2. The heat dissipation device of claim 1, wherein the heat radiator is located in transverse directions by the first and second walls, and is located in lengthwise directions by the baffles.

3. The heat dissipation device of claim 1, further comprising a heat pipe connecting with the heat radiator and the base plate, the heat pipe comprising an evaporating portion extending through an undercut of the first wall and sandwiched by the base plate and the heat radiator, and a condensing portion extending through the heat radiator.

4. The heat dissipation device of claim 1, wherein each of the arms defines a cutout and comprises a clasp located at the cutout.

5. The heat dissipation device of claim 4, wherein the bracket is a single piece of metal, the clasp of each arm being a punched clasp.

6. The heat dissipation device of claim 4, wherein the base plate comprises an inserting portion protruding upward into the opening of the bracket, and a main portion sandwiched between the blocking parts of the clasps and the arms of the bracket, and the main portion is wider than the inserting portion.

7. The heat dissipation device of claim 1, wherein the heat radiator defines two grooves at the lateral locating surface corresponding to the baffles of the bracket and the tabs of the fan holder.

8. The heat dissipation device of claim 1, wherein the heat radiator comprises a plurality of fins spaced from each other to define a plurality of air channels exposed at the lateral locating surface.

9. A heat dissipation device for an electronic component, the heat dissipation device comprising:
a base plate having a first face and a second face at opposite sides thereof, the first face provided for contacting the electronic component;
a bracket engaging the base plate, the bracket comprising two parallel arms, the bracket defining an opening between the arms, each of the arms including at least a clasp extending downwardly therefrom, the at least a clasp of each arm comprising a blocking part, the bracket further comprising two baffles at one of the arms; and
a heat radiator comprising a plurality of fins stacked one on the other and abutting the second face of the base plate and the bracket, the fins spaced from each other to define a plurality of air channels;
a fan holder comprising a top plate, and a clamping leg and two tabs extending downwardly from the top plate, the clamping leg fittingly received in a slot defined in the heat radiator; and
a fan mounted on the baffles of the bracket and the tabs of the fan holder to provide airflow toward the air channels of the heat radiator;
wherein the base plate is received in the opening of the bracket and sandwiched and secured by the blocking parts of the clasps and the arms of the bracket.

10. The heat dissipation device of claim 9, wherein each of the arms defines at least a cutout, and the at least a clasp of each arm is located at the at least a cutout.

11. The heat dissipation device of claim 10, wherein the bracket is a single piece of metal, the at least a clasp of each arm being a punched clasp.

12. The heat dissipation device of claim 9, wherein the bracket further comprises a first wall and a second wall interconnecting ends of the arms, the first wall, the second wall, and the arms cooperatively surrounding the opening.

13. The heat dissipation device of claim 12, wherein the base plate comprises an inserting portion protruding upward into the opening of the bracket, and a main portion sandwiched between the blocking parts of the clasps and the arms of the bracket, and the main portion is wider than the inserting portion.

14. The heat dissipation device of claim 12, wherein the first wall defines a first undercut and the second wall defines a second undercut, the base plate extending through the first undercut and abutting against the second wall at the second undercut.

15. The heat dissipation device of claim 9, wherein the heat radiator defines two grooves at the lateral locating surface corresponding to the baffles of the bracket and the tabs of the fan holder.

16. A heat dissipation device for an electronic component, the heat dissipation device comprising:
a base plate having a first face and a second face at opposite sides thereof, the first face provided for contacting the electronic component;
a bracket engaged with the base plate, the bracket comprising two parallel arms, the bracket defining an opening between the arms, each of the arms including at least a clasp extending downwardly therefrom, the at least a clasp of each arm comprising a blocking part, the bracket further comprising a baffle portion at one of the arms; and
a heat radiator comprising a plurality of fins stacked one on the other in a horizontal direction and abutting the second face of the base plate and the bracket, the fins spaced from each other to define a plurality of air channels, the heat radiator having a slot defined therein;
a fan holder comprising a top plate, and a clamping leg and a tab portion extending downwardly from the top plate, the clamping leg fittingly received in the slot of the heat radiator; and
a fan mounted on the baffle portion of the bracket and the tab portion of the fan holder and thereby positioned to provide airflow toward the air channels of the heat radiator;
wherein the base plate is received in the opening of the bracket and sandwiched and secured by the blocking parts of the clasps and the arms of the bracket.

17. The heat dissipation device of claim 16, wherein each of the arms defines at least a cutout, and the at least a clasp of each arm is located at the at least a cutout.

18. The heat dissipation device of claim 17, wherein the bracket is a single piece of metal, the at least a clasp of each arm being a punched clasp.

19. The heat dissipation device of claim 16, wherein the bracket further comprises a first wall and a second wall interconnecting ends of the arms, the first wall, the second wall, and the arms cooperatively surrounding the opening.
